(19) United States
(12) Patent Application Publication
(10) Pub. No.: US 2024/0427493 A1
(43) Pub. Date: Dec. 26, 2024

(54) Intelligent, Predictive Memory Management System and Method

(71) Applicant: MEXT Corporation, Santa Clara, CA (US)

(72) Inventors: Gary SMERDON, Monterey, CA (US); David P. REED, Needham, MA (US); Carl WALDSPURGER, Palo Alto, CA (US); Eric SCARAMUZZO, San Jose, CA (US)

(73) Assignee: MEXT Corporation, Santa Clara, CA (US)

(21) Appl. No.: 18/751,088

(22) Filed: Jun. 21, 2024

Related U.S. Application Data
(60) Provisional application No. 63/509,733, filed on Jun. 22, 2023.

(51) Int. Cl. G06F 3/06

(52) U.S. Cl. CPC G06F 3/0611; G06F 3/0647; G06F 3/0673

(57) ABSTRACT

A memory management system inputs from an operating system to a machine learning component information corresponding to events associated with a process running on the OS. The machine learning component, which is configured within a software appliance that is logically separate from the OS synthesizes a page access model from at least one sequence of the events inputted from the OS; identifies patterns in the at least one sequence of the events; and, in real time, predicts page misses by the process in the relatively faster memory that are likely to happen by the process and identifies most-likely-to-be-missed pages that the process may attempt to access in the relatively faster memory. At least some of the most-likely-to-be accessed pages are moved from the relatively slower memory to the relatively faster memory.

### REFERENCE TO RELATED APPLICATIONS

This application claims priority of U.S. Provisional Patent Application No. 63/509,733, filed 22 Jun. 2023.

### TECHNICAL FIELD

This invention relates to computer memory management.

### BACKGROUND ART

Memory is becoming a primary limiting factor in many modern computing systems, and the need for greater memory availability, capacity and speed is overtaking the previously dominating bottleneck of processing capacity and “silicon space” often expressed by “Moore's Law”.

A computing system generally uses many different memory technologies, including in systems that operate with non-uniform memory access (NUMA). These memory technologies may be viewed as being arranged in “tiers” with varying speeds. The fastest memory other than CPU registers themselves is usually static random access memory (SRAM), which is used to implement different caches (such as the L1, L2 and L3 caches) and is thus both physically and logically closest to the CPU core. Slower memory such as dynamic random access memory DRAM is then often used for the system's main storage technology. These relatively fast SRAM and DRAM memory technologies are thus used for primary system memory. An even slower technology such as “flash memory” found in a solid-state drive (SSD) is often used for secondary storage, although RAM-based mass-storage devices are available as well. Memory devices such as SSD are typically on the order of thousands of times slower than DRAM.

Since processing speed depends heavily on the speed of both read and write access to memory, both primary and secondary, memory speed is always important, but for many applications it is essential. As just one of countless examples, a single 4 MB image may require 1024 pages of memory with a 4 KB page size. Many application servers, for example, spend more than 50%—and often significantly more—of the time stalled on memory, especially when they use a memory storage appliance with which they communicate via a network.

One might think that the easiest way to increase read and write speed would simply be to use the fast SRAM memory technology everywhere. This would, however, ignore the much higher and usually prohibitive cost of doing so.

One method that attempts to reduce memory latency is known as “pre-fetching”. Implemented using either software, or hardware, or both, pre-fetching involves the loading of a resource, such as pages or other blocks of memory, before it is required. For example, pages of memory can be fetched into a cache in anticipation of expected imminent demand for them. In general, the idea is that system software or, in some cases, the running program, attempts to fetch pages that it knows it will likely need.

Many pre-fetching techniques involve a workload-independent choice of a statically related memory page to prefetch, under control of an OS kernel heuristic that is supposedly also workload-independent. One example is the fetching of the next higher page address, or the next N pages. Because of its workload-independence, pre-fetching is often inaccurate and may in some cases even increase latency, since it typically relies on a locality assumption, that is, that the most likely page(s) to be needed next are simply the next one(s) in the address space. The time and space it takes to pre-fetch pages that are not needed is thus wasted.

The workload-independent nature of such pre-fetching techniques also often causes problems of timing: fetching memory pages too early clutters memory, whereas fetching pages too late defeats the whole purpose of pre-fetching.

Yet another weakness of most existing pre-fetching schemes is that they fail to learn from their mistakes. In other words, prediction errors are not used to improve results. Moreover, most of these schemes fail to take into account structure and behavior but rather consider only the address miss sequence and program counter.

Various proposals to use machine learning (ML) techniques to improve the processor cache hit rate of a device include the systems known as Voyager (see Shi et al., “A Hierarchical Neural Model of Data Prefetching”, Proceedings of the 26th ACM International Conference on Architectural Support for Programming Languages and Operating Systems (ASPLOS '21), Apr. 19-23, 2021, Virtual, ACM, New York) and TransFetch (see Zhang et al., “Fine-Grained Address Segmentation for Attention-Based Variable-Degree Prefetching”, Conference on Computing Frontiers (CF′22), May 17-19, 2022, Torino, Italy, both of which are hardware approaches to improving performance.

What is needed is therefore a memory-management system and method that are more accurate and thus less wasteful of time and space than what is available at present.

### BRIEF DESCRIPTION OF THE DRAWINGS

FIG. 1 illustrates a client and an Intelligent Software-Defined Memory (ISDM) appliance, as well as one possible method for communication between the two.

FIG. 2 illustrates the main components of the ISDM appliance.

FIG. 3 illustrates components within the client.

### DESCRIPTION OF THE INVENTION

Embodiments of the invention implement a novel Intelligent Software-Defined Memory (ISDM) system and related method of operation, which may comprise an Artificial Intelligence (AI)-driven memory appliance. For succinctness, the invention or components of the appliance are occasionally also referred to below and in drawings using the term “MEXT”, derived from the name “Memory EXTraordinaire” used internally for a prototype of the invention, as well as the name of the applicant company.

In general, the invention implements a memory management method involving a computer program running in an operating system that supports virtual memory (referred to in this disclosure simply as “the operating system” or the “OS”) on a computing machine, where the “computing machine” either contains or can communicate with a separate (either within the chassis or across a network) “memory service virtual device”.

The virtual memory OS's virtual memory pages can be either bound to the physical memory directly controlled by the operating system, or may be moved to the “memory service virtual device”—the ISDM-which contains memory that need not be tightly connected to the processors running the computer program on the VM OS.

In a preferred embodiment, the ISDM is logically separate from the OS, such that its operation does not require any modification of the OS itself. The operating system (on page misses and also to reclaim expensive memory) may, however, communicate with the memory service virtual device to transfer virtual memory pages back and forth on demand. The operating system also transmits, or at least exposes, “events” that occur during the execution of the computer program to the memory service virtual device. These events comprise at least all the page misses that require fetching pages from the memory service virtual device, but may/should include other activity related to the process(es) executing in the computer programs running on the operating system. On the memory service virtual device, a machine learning component receives these events and applies machine learning techniques to find and predict patterns in event sequences.

The machine learning component maintains a predictive model, such as a recursive neural network model, that may be used online, in real-time, to predict page misses that are likely to happen in the near future on the operating system. The predictions are used to maintain the most likely future pages to be accessed in the memory of the main computer system so that the operating system will be able to load them with negligible overhead. The machine learning component may base its decisions solely on its model, which is synthesized from the stream of events that the operating system has provided.

The embodiments intelligently evaluate an actual workload to help identify which pages or other blocks of memory should be migrated—in particular, pushed—from relatively slower or more remote memory into relatively faster or more local memory so as to reduce memory latency. An “artificial intelligence” (AI) system is trained on a particular application workload, or a series of similar workloads, such as multiple runs of an application over time, in particular, with respect to their memory operations. Based on this training, the memory appliance then may monitor a current workload and be able to better predict which memory pages are most likely to be needed next, and can then have these pages pushed to faster or more local memory before they are needed.

Embodiments are described below primarily in the context of clients that use the Linux operating system, but this is by way of non-limiting example. The MEXT system may be used to improve the operation of any OS that operates with virtual memory, including, for example, Unix, modern Windows, and Mach, among others.

For the sake of succinctness, but without loss of generality, unless a distinction is explicitly made below, the terms “artificial intelligence” (AI) and “machine learning” are used in this disclosure to encompass three types of systems that are often referred to interchangeably, but are conceptually at least somewhat different, or rather, have different levels of specialization. These three are “Artificial Intelligence (AI)”, “Machine Learning (ML),” and “Deep Learning (DL)”, and any or, indeed, an ensemble of more than one of these routines, may be chosen to implement the “machine learning” or “AI” component in embodiments since they may all be “trained” and may statically or iteratively “learn” based on inputs.

“Artificial Intelligence” is the broadest concept and is generally taken to be an implementation of the notion that a computing system can be made to carry out tasks that appear to simulate human intelligence. “Machine Learning” (ML) may be viewed as a conceptual subset of AI and is based on the idea that systems can learn from data, identify patterns, and make decisions with minimal human intervention. “Deep Learning” may in turn be considered a subset of ML and typically involves neural networks with a large number of layers; hence, “deep”. These neural networks attempt to simulate the human decision-making process of the human brain, which may similarly be viewed as an interconnection of an exceptionally large number of nodes (synapses). This structure often enables a computing system to solve complex problems even when using a data set that is very diverse and unstructured. Given the description below, those skilled in the art of AI/ML/DL techniques will be able to decide which routine they prefer to use to perform the predictive tasks of the MEXT system. Again, merely for the sake of succinctness, the terms “artificial intelligence”, “AI”, “AI/ML”, “machine learning”, etc., are to be taken to mean any AI/ML/DL routine chosen by the system designer.

At a high level, the invention provides a prediction-based memory migration scheme that ensures that pages are in the right place before they are needed, where need is estimated based on data relating to the performance of a process as it is running. AI and ML techniques are used to support such predictions so that the frequency of correct predictions and their timeliness allows the use of much cheaper memory technologies, with lower power consumption, such as flash, that were traditionally used only for persistent storage.

Those skilled in the art of neural network based AI will be able to choose an AI/ML routine from the large number currently available that has a desired balance between training speed, prediction accuracy, and computational burden for given use cases. One AI routine that may be used is a Hidden Markov Model. Both Markov and Hidden Markov models are designed to use input data that can be represented as a sequence of observations over time. Hidden Markov models function stochastically and are well suited in applications for which observed data is modeled as a series of outputs generated by one of several (hidden) internal states, in this case, of the client process. Both a General Purpose Transformer model using a Deep Neural Network and a multi-layer perceptron (MLP) model were also tested successfully. These are only three of many possible choices of AI/ML routines that may be used in this invention. Furthermore, reference to “the” AI component 210 is not to be read as limiting this component to any single type of learning engine, although that is an option; rather, “the” component 210—whether referred to as the “AI” or machine learning component—may comprise an ensemble of engines, such as a combination of multiple AI, ML, and or DL routines, which may operate both in real-time and offline if preferred by the system designer.

The MEXT system preferably examines and updates its predictive ability dynamically, based on actual run-time behavior, which also allows it to take advantage of and adjust its parameters based on observed run-time prediction errors, that is, on real-time feedback. Embodiments of the MEXT system create its predictive model—an access prediction model—by receiving a stream of events sent by the running system, where such “events” are typically small messages emitted when something of interest to MEXT in the operating system (OS) occurs. The primary example of such events are page miss events-events that occur when a page of memory is not present in the running system, but is instead being held on the MEXT virtual device. Table 1 (below) gives several other examples of events, although the system designer may specify others. Requiring no specific hardware support, the computer-executable code that embodies the MEXT system can be embedded is receives a rich “stream” of system events, which are fed into the training of a chosen AI/ML component to discover what connections and correlations are predictive of future resource requirements. These advantages are not achieved by prior art, for example, that relies on ML-based cache-line prefetching, since a processor's hardware cache size is static and cannot be modified dynamically.

Note the difference from the current, essentially “fixed assumption” solutions. To illustrate, assume that, most of the time, when in a particular state or close to that state, an application will tend to execute a branch instruction. Many known solutions that do not operate based on workload will tend either to pull the next N memory pages, which may be in the wrong branch, or they will attempt to pull pages corresponding to every possible branch, which wastes both time and space. In contrast, embodiments of this invention, having been trained on the same or analogous workloads, will be able to select the most probable branch, and thus the most probably needed pages, which it can then push so that they are available in fast system memory before they are needed.

Embodiments may evaluate streams of events that occur while the workload is executing on a processor, where events are ordered in time or other causality-induced sequences. The MEXT system uses events that occur during the running of the existing operating system's memory management algorithms, and contain descriptive information such as the virtual memory address of a page miss, the creation and destruction of a virtual address space, etc. The MEXT system may, moreover, operate independently of any transfer request by a process running on the OS, and independently of any page miss handler or other memory management algorithm controlled by the OS.

In general, embodiments of the invention may be used to advantage to reduce memory latency in any situation in which the information being accessed in a workload is non-random with respect to the content of the corresponding memory pages, blocks, etc. Such information may also include information relating to such things as page compressibility (e.g. compression ratio), page entropy, following “pointers” contained in page data, etc.

One aspect of embodiments is that they may implement AI-driven, auto-tiering of memory “pages”, which should be read as meaning any set of memory data that is moved between devices as a unit, including but not limited to the conventional concept of a memory “page”. The goal is to be able to write to local DRAM, and to transparently push “cold” data to more remote, slower, “far” memory, as fast as possible. For read operations, the client system reads from local DRAM the vast majority of the time. On a page miss, however, the related pages are pushed to local DRAM (for example, from local flash, or from remote DRAM/flash), based on an AI-driven push operation, again, as fast as possible, so as to place memory pages optimally before they are requested. The MEXT system may thus remain transparent to the client process in that it moves pages that it predicts will be needed into DRAM before the client even knows it needs them, and also pushes cold pages off to a more remote device, again in a manner transparent to the client process. Note that this is different from many existing systems, which pull memory (see immediately below) they think may be needed.

At this point it is helpful to clarify how certain terms are meant to be understood in the context of this invention, in particular, “pre-fetching”, “pushing” and “pulling”. All three aim to get the page to the main memory before it is needed, or soon after the need is known. As such, all involve a form of “pre-motion” of pages.

As used here, “pulling” occurs when the transfers are requested by the executing process and uses only information from the executing process's current state. “Fetching” may then be considered a form of “pulling”, if and only if it is caused by the process execution logic and uses only local information available to the executing process.

In contrast, “pushing”, which is unique to this invention, is done by a separate agency of the system, and in particular by the virtual smart memory device—the MEXT system—that the operating system attaches to. This system, and the related process, uses information in a system model that is derived by an AI/ML routine that uses at least the history of memory page miss events, but may also use other information about prior system behavior that can be used to infer future probable behavior. The manner in which this intelligent evaluation is carried out, and the software and hardware components and structures used, will now be described.

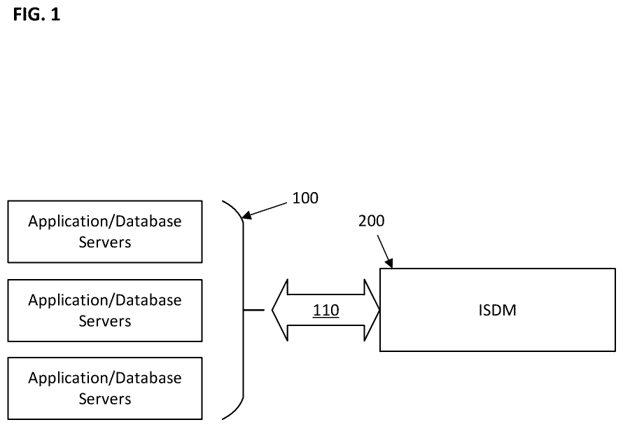

FIG. 1 illustrates, at a high level, how a “client”, which may, for example, contain application and/or database servers 100, communicates with the novel ISDM appliance 200. In one embodiment, communication is over a network 110, for example, such as Ethernet, Infiniband, CXL, etc. In another embodiment, however, communication is “direct”, for example, via shared memory or other mechanisms for inter-process communication such as “Unix domain sockets” (using a networking interface) and “named pipes”, such that the ISDM appliance could even be installed within the client itself. In such implementations, the appliance 200 may reside on the same host as the client, and use local SSD, NVMe, CXL attached memory, etc., as the slow, “far” memory. The distinction between “client” and “appliance” is therefore not physical in every implementation, but may be primarily logical.

Although components enabling the embodiments could be “permanently” architected into the system software of the servers, in the preferred case, the ISDM, that is, the MEXT system, is logically separate from the OS. In these embodiments, a plug-in may be installed in the servers to communicate with and pass or expose information to the ISDM appliance. This would avoid the need to modify the existing operating system and allows use of the existing or future server and networking infrastructure.

The software components of the ISDM system may be installed even in an existing server to transform it into the ISDM appliance. Note that this is one advantage of such an embodiment: servers that may have outlived their usefulness in other contexts may be repurposed to host the invention and thus extend their useful lifespan. The ISDM appliance may be implemented to have several advantageous features, such as transparent auto-tiering of local and remote memory, including DRAM and FLASH, AI-driven continual optimization, and a low-latency architecture. A memory analyzer component, for example, the DAMON Linux component may exist in the client to measure application memory usage in the servers and to optimize the memory configuration, for example, based on workload-specific memory access patterns; it may then either in real-time or off-line carry out AI-based optimization. DAMON provides low-level information about memory activity, e.g. page “heat”, which may be used for memory analysis.

In some embodiments, either the client itself, or the AI enabled ISDM, or both, identifies “trigger events” (for example, pages or other units or features, down to the level of individual commands). Since the concept of a memory page is well understood, and because this is anticipated to be a common type of trigger event, embodiments are described below primarily in the context of a trigger page being the trigger event. This is by way of example only; given this disclosure, skilled system programmers will know how to apply the techniques described below to other types of trigger events.

Note that a page miss itself may be interpreted as a trigger event. Even conventional mechanisms may react to page misses, but, as mentioned above, how they are configured to deal with this is greatly limited compared with this invention. For example, the AI predictor 220 may make different predictions based on the trigger event's “predictive power”—that is, how much information about the specific workload is embedded into the AI predictor by its learning. The AI routine according to embodiments of this invention incorporates into its selection of trigger pages additional learning about the workload, so the trigger mechanism extends the effectiveness of learned patterns.

Memory misses occur in processor hardware, which the OS sets up as a virtual emulator of an application virtual processor (core). The logic of the running application program combines with the logic of the OS such that only some of the application's memory accesses (read or write) will trigger hardware page misses that need to be dealt with and restarted. Only some memory access operations are thus “faulting accesses”, which cause the hardware to take a fault.

When the appliance detects the occurrence of at least one trigger event, and based on the type of detected trigger event(s), the AI component calculates an access score, for example, a probability, and uses that as a criterion for determining which pages to move. As one example, the access score may be the probability that the client will refer to other pages within any set or variable number k of subsequent memory access operations, such as read operations (note that memory write operations may also be an event in that they may also lead to page faults) and identifies those for which this probability is high enough to justify pushing them in advance of use. As another access score, the AI component may calculate the probability that the predicted pages are likely to be needed (accessed) before other, colder pages that are already resident in memory. Still another alternative score may be the expected amount of time before a page will be accessed (i.e. to push those pages expected to be accessed soonest). Examples of still other items that the system could score include how much free space is available for where the pages are moved, how much bandwidth is available to move the pages (in the network-attached embodiment). Yet another scoring criterion could be how “old” (unaccessed) the pages are in the area where the MEXT system would move the pages, such that older but not yet evicted pages may be replaced by “fresher” pages that are available—the score of the fresher pages would thus be higher than the current score of the pages that were previously moved.

Scores may also be made adjustable, according to the success/failure of predictions-scores may be raised/lowered depending on whether corresponding predictions succeeded/failed.

A threshold access score, such as a threshold probability, and the learned page-successor-access scores (again, which may be probabilities) may be based on observation of specific workloads features, for example, the executing application program's name, its address space size, which process is running, recent history and other contextual features about the running application. The threshold score may be pre-determined, or it may be made adaptive. For example, if too many pages are identified as being likely “candidates” for being pushed, the AI routine may increase the threshold to reduce the number of candidate pages; too few candidate pages being identified may indicate to the AI routine a need to reduce the threshold. In some circumstances, however, there may in fact be very few high-scoring candidate pages. The system designer may decide how to configure the threshold score depending on the anticipated needs of a given client, assuming it is even possible to anticipate those needs.

The AI component may thus predict the page misses according to an access prediction criterion, which may be the output of the chosen model. As one option, the output may be a list of pages currently in the ISDM that the model estimates to be highly likely to be needed in the near future, which may be defined in different ways, such as number of events, page accesses, etc. The list may also be ranked according to the model's estimated likelihood that the respective pages will be needed in the near future. The AI component may also be configured to choose a cutoff of the ranked list, for example, by probability or a maximum list size, which can be adjusted as the system runs to optimize both the dimensionality of the model and the system resources used for pages moving to faster memory.

The more the AI routine is trained, the better its predictions will tend to be, such that memory latency for a given workload will typically decrease, in many cases by orders of magnitude. Note that many existing, static routines that use pre-fetching lack such ability to improve performance over time since they are, by definition, static.

One input to the AI routine used in the MEXT system may thus be memory addresses, with indications of “hit” or “miss” serving as the result that is used to adjust the parameters of the routine. Inputting contextual embedding information, such as process/thread scheduling events onto and off of processors, in addition to just memory accesses and misses, can also make the AI routine more efficient. Other input parameters are mentioned below; indeed, the ability to observe and learn from other types of inputs is one advantage of embodiments of the invention.

Some embodiments may also use sampling of page addresses and/or other context information in the input stream to the machine learning component. In some embodiments, sampling may be “fixed”, for example, sampling some predetermined percentage (such as 10%) of the page addresses and/or other input events.

In other embodiments, sampling may be made adaptive, for example, as a function of an accuracy rate of the machine learning component. In these embodiments, the AI routine may elide any predetermined inputs and features, such as some of the page addresses used as inputs to train online AI/ML models and/or additional associated context information (e.g. pid, return PC, etc) in order to reduce resource consumption while still maintaining good predictive performance. In other words, the AI/ML component may use as its input only a subset of the available input information and subsequence of events.

The reduced computational cost using sampling may then enable training to be performed on a “regular” CPU, whereas sufficiently fast processing in many cases may require running the ISDM appliance, or at least the AI component, on a GPU.

Early experimentation with the well-known Transformer-based AI model (originally developed by Google), using only small subsequences of pages-instead of all pages-displayed almost the same high model accuracy while reducing training time significantly. As one example, sampling 20% of the input may be accomplished by using 32 (or some other “active” number) in a row as inputs, then skipping the next 128 (or some other chosen “elided” number), then keeping the next 32, skipping the next 128, etc. The sampling procedure need not be deterministic and may employ randomization. The sampling rate-specifying the fraction of page addresses that are used—can further be adjusted adaptively based on the rate at which the model is improving, for example, increasing the rate when model accuracy is poor, and decreasing it when model accuracy is high.

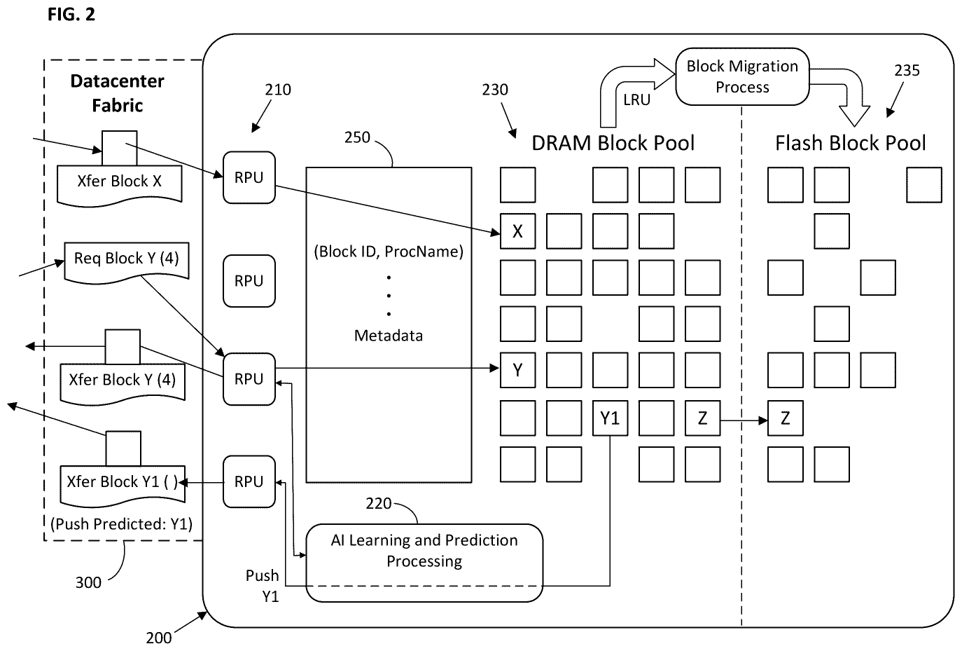

FIG. 2 is a diagram that illustrates one high-level example of how the ISDM architecture 200 may be configured, and also how the MEXT appliance is able to process multiple-even many-events in parallel because they are substantially asynchronous. In the figure, “RPU” indicates Request Processing Units (several of which are numbered collectively as 210) and “LRU” stands for “Least-Recently Used”. In FIG. 2, the DRAM block Y1 has been identified by the AI and Prediction Processing component 220 as being the block in the DRAM Block Pool 230 that has the highest probability of being needed to be pushed next, or soon, and is thus pushed to the system executing the corresponding workload. Data blocks X and Y represent a “normal” block write and read, respectively, whereas block Z has been identified as being relatively infrequently used, and is thus transferred from the relatively faster or more local DRAM block pool 230 to the relatively slower or more remote flash block pool 235. As one option, the system may order events according to the timestamp in each event, which would then create a usable total ordering.

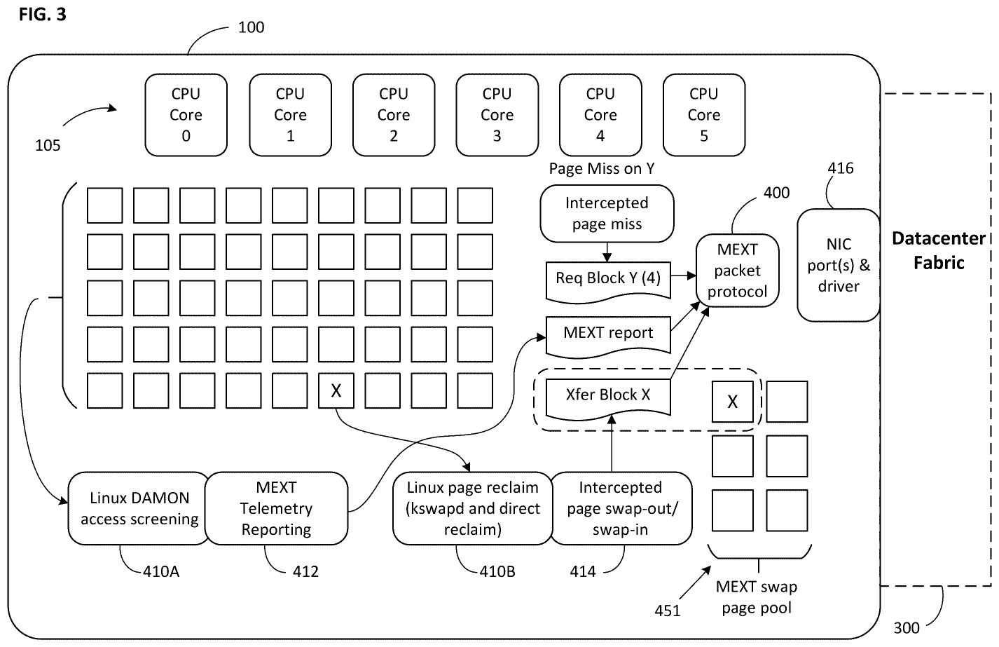

In the network-attached embodiment, there are thus effectively at least two separate DRAM caches for pages—at least one (230) on the ISDM appliance 200 itself, which serves as a relatively large cache of the ISDM appliance flash storage (235), and at least one other-shown as the MEXT swap page pool 451 in FIG. 3—on the client 100 that serves as a relatively small cache of the pages pushed from the ISDM. It is not necessary for the appliance to push pages directly into the client's local memory but could rather first push pages from NVMe/SSD in the network appliance to DRAM in the appliance.

In the direct embodiment, there is no separate appliance, that is, the appliance and the client run on the same hardware platform, and thus no separate ISDM DRAM block pool 230 is needed, but rather only the MEXT swap page pool 451 on the client. In other words, for the direct embodiment, there is no need for two separate DRAM page caches, since all of the required DRAM is local to the client-no DRAM will be “remote”. In the direct embodiment, the memory service virtual device that ISDM provides may therefore store data primarily in flash 235, and push predicted pages into a MEXT swap page pool 451 (in local DRAM).

The MEXT swap page pool 451 and its corresponding index are not needed in the direct embodiment, and can therefore be bypassed. Trigger pages that should be kept in the MEXT swap page pool should, however, be kept in memory, so as not to be moved to flash or slow memory.

In FIG. 2, the two illustrated instances of Y (4) represent a request (for example, access by the application) and the response to that request (that is, resolving the page fault for this page). Here, as FIG. 3 illustrates (see below), the parenthetical designation associated with the different Y requests thus indicates association with a CPU core; lack of such reference, such as Y1 ( ) indicates that the respective push was not associated with any client core, but was rather pushed autonomously by the AI engine.

There may thus be different types of interactions between a client and the ISDM appliance 200 upon the detection of a trigger page (or other trigger event), and where this access occurs. As one example, assume the client itself chooses to pull a page from the ISDM 200, and this page is a trigger page. The ISDM may then send the pulled page, but also push additional pages for which it determines there is a high probability of need soon. As another example, assume the client accesses a trigger page on the client itself. A notification may then be sent to the ISDM, which then decides what action to take, such as pushing additional page(s) to the client. As yet another example, the ISDM may independently, through its AI capability, identify a Trigger Page based on current client activity. The ISDM may then push these Trigger Page(s) to the Client system.

FIG. 3 illustrates at a high level one example of an ISDM client kernel extension in a Linux-based client, as well as various processing steps in a related method of operation. In particular, the figure shows how MEXT components for generating input data (a “report”) to a MEXT packet protocol component 400 (in the network-attached embodiment) cooperate with existing Linux components, such as the known Linux Data Access MONitoring (DAMON) framework subsystem 410A and page reclaim utilities 410B of the Linux kernel. These components include a telemetry reporting component 412 and a page swap/out component 414. Note that in the direct embodiment, communication between the ISDM and the client need not be over a network, such that the packet protocol component 400 will not be necessary; rather, communication may take place via a shared memory interface.

As for the component 412, “telemetry” refers to the information that is sent concerning the client's running computation to the AI Learning and Prediction Processing component 220. This information may include, for example, details about processes running in the client, their address space structures, recent history (for example, the last n misses and possibly even hits, instead of just one). As its name implies, the intercepted page component 414 performs the known functions of page swapping (both swap-out, and swap-in), in this case, between different tiers of memory devices. Different techniques may be used to implement the swap-out component 414, such as kprobes or a custom block device. One example is the operating system component known as a Block Device Driver. Instead of using a conventional block storage device for swap space, however, in a preferred embodiment the MEXT systems uses a dynamically installed “Virtual Block Device”, which is implemented in software only, and which sends requests and pages across a dedicated communications link. This communications link may in turn be implemented either over a network path (a “network-attached embodiment”) or through shared physical memory (in a “direct” embodiment).

The MEXT system may be used to improve memory management for any given arrangement of memory. Table 1 below illustrates, however, examples of information items, in particular, page block features, that are likely to be useful for the AI learning routine that takes as its input a stream of events that include features captured at the time of the event. Table 1 also indicates what information the AI routine may be able to gain or “infer” based on the feature, source and/or event so as to improve its predictive ability. Some may lead to greater efficiency in some contexts than in others.

For example, a logical name for a page block that is stable across many runs of a workload, even though the system is restarted, might be [process name, offset of page in process address space section]. Note that many processes will have the same name, and may be concurrently running. This is actually advantageous, because the AI learning may in most cases be assumed to apply to all instances of the same application. So, for example, factors that generally apply to any instance of program X's pages would depend on this kind of “name” for pages. As another example, a logical name for a page block that is stable while the OS is up might be [process id, offset of page in process address space section, time page block was first accessed in process address space]. (Note that the time the page was created handles the problem of process identifiers being reused.)

TABLE 1

| Feature | Source/Event | Utility/Value |
|---|---|---|
| Process (thread) ID | Kernel maps at reclaim | Userspace location |
| Process name | Per-thread data of | Application |
| | process mapping the | identity from |
| | page block at reclaim | user perspective |
| File mapping of page | Page buffer pool | (If page blocks are |
| block: inode, name, | | swapped out |
| dnode, block offset | | to MEXT) the |
| | | long term name |
| | | of the page |
| Offset of page | At swapout event, | A standard |
| in process | get from | “name” for the |
| virtual address | vm paging data of each | page within |
| space section | process that | the process |
| (heap, stack) | maps the page | address space. |
| Pressure stall | system metrics | indicates |
| information | (obtained | memory-system |
| (PSI) metrics | from kernel) | pressure |
| Time swapped out | System uptime | Clue as to |
| | at reclaim of | recency of use |
| | page block | |
| Time last in use | System uptime | More granular |
| | at beginning | info as to |
| | of last DAMON | recency of use |
| | sweep of | |
| | page block when | |
| | accessed bit | |
| | was set | |
| Process | Size of process | Indicates |
| address space | address space | something about |
| size when | containing the | the process's |
| swapped out | page block | frequency of |
| | when it was | access (larger |
| | swapped out | address |
| | | spaces access |
| | | each page |
| | | less frequently) |
| Process | Process status | Indicates |
| cumulative page | counters for | heaviness of |
| fault data | major, minor, | swapping in process |
| when swapped | and other page | |
| out | faults | |
| Process cumulative | Scheduler data for | Indicates |
| runtime when | process/thread | heaviness of |
| block was | | swapping in process |
| swapped out | | |
| Process I/O | On swap out, | Indicates |
| waiting when | was process | how long until |
| block was | using this page | this page might be |
| swapped out | block waiting | needed. |
| | for I/O (and | |
| | maybe estimated | |
| | time of waiting | |
| | before | |
| | needing a page) | |
| | Indicates | |
| | how long until | |
| | this page | |
| | might be needed. | |
| Process | (Comes from | With address |
| working set size | DAMON's most | space size, |
| at swap out | recent scan of recently | indicates how much |
| | accessed pages) | of address space |
| | pages whose accessed | seems to be |
| | bits are set in the | needed |
| | process map at swapout. | |
| Page access | The active | Infer something |
| at swapout | protection for the | about |
| (read-only, | page in the kernel. | page usage |
| read-write, | | |
| execute) | | |
| Page sharing | Whether the | Infer role of |
| by more | page is shared | page in inter- |
| than one process/ | at swapout time | process |
| thread at swapout | | communication |
| Page unaccessed time | DAMON scan | Infer coldness |
| exceeds threshold. | | of page |
| Page accessed | DAMON scan | Infer access |
| time very | | lifetime to |
| short before | | cause early |
| unaccessed | | reclaim before |
| | | it is LRU |
| | | among pages |
| Page accessed | Swap out aborted | Infer that |
| shortly | in process, | discouraging |
| after swapout | or at a time shortly | swapout of |
| | after it is | the page may |
| | moved to appliance | be a good idea |
| Last n pages | At page miss | Infer “trigger page” |
| accessed by | time, capture last n | relationships-n |
| context (e.g. process | page accesses, and | is small |
| id (pid), thread | send accompanying | enough to |
| id (tid), etc.) before | page when it is | capture easily. |
| most recent page | swapped out. (Use | |
| miss on this page | processor page | |
| | access log) | |
| Time page | At the time of | Inferring the |
| block was first | the first load | relative age |
| accessed in | or store into a | of the page within a |
| the virtual | page (a minor | process/thread's |
| memory of a context. | page fault that allocates | lifetime. |
| | memory for that | |
| | page block), | |
| | the system clock is read. | |

Concerning trigger pages, when a Trigger Page is accessed, it is not required for it to send a request to pre-fetch specific information; rather, it may send a notification to the ISDM appliance 200, which then decides which, if any, additional pages of information is to be pushed to the requesting Client system. The ISDM appliance may use various methods from simple routines to advanced AI inputs and real-time AI learning to make this decision.

One entry in Table 1 above helps bring out an advantage of the invention, namely, that the ISDM system can operate on inactive, stale, “cold” pages, and swap them out to slower memory if a page has not been accessed within a set time threshold. The source/event in this case may be a result of the data access monitoring (“DAMON”) framework subsystem found in the Linux kernel.

The success of whether the pages that were sent are actually used is preferably monitored to provide strong feedback to the real-time AI engine. If they are used, then they can be deleted from the ISDM appliance to free up space. If they aren't used within some pre-determined or available space-dependent time, they can be evicted from the client to free up space (since they will still be on the ISDM appliance)

The ISDM system may identify specific pages of memory as Trigger Pages. If these Trigger Pages are in the ISDM, they may be pushed to the client system. This eliminates the latency of the client system having to pull it from the ISDM. Note that, in a “local” or “direct” embodiment, the ISDM MEXT appliance need not carry out operations on the client system over a network, but rather communication between the client and the MEXT AI/ML engine may take place locally, via shared memory.

### ISDM Protocol Overview

Embodiments of the MEXT system may implement different protocols to carry out the novel, intelligent, workload-based, predictive memory management method described above. As mentioned above, the MEXT system may be implemented as a “network-attached embodiment”, in which the MEXT system communicates with the client over a network, or as “direct embodiment”, in which the MEXT system and the client communicate using shared memory.

To better understand the interaction between the client and ISDM appliance in the network-attached embodiment, an example of one successfully tested protocol will now be described. Any modifications to the protocol described below needed to accommodate the direct embodiment will primarily be simplifications in that network-specific features (including network 110 depicted in FIG. 1) will not be needed; those skilled in operating system-level programming will be able to make any such modifications, given this disclosure.

FIGS. 2 and 3 depict a Datacenter Fabric 300 to represent a communications path and some information that may be transferred over it. In some embodiments, such as the “network-attached” embodiment, this may include a network. As mentioned above, however, the communication function may be realized by shared memory that the operating system can transfer pages to and from by copying. FIGS. 2 and 3 therefore illustrate not only various physical components of the respective systems, such as CPU core(s) and memory, but also various logical structures and information flows.

FIG. 3 depicts a configuration in which the client computing system has a set 105 of more than one CPU core (CPU Core 0, . . . , CPU Core 5). Optionally, one or more CPU Cores, for example CPU Core 5 as depicted in FIG. 3, could be dedicated to running the ISDM appliance. This is not required by the invention; instead, for example, in the direct embodiment, the ISDM appliance could itself be scheduled by the OS and time-multiplexed on general cores like other workloads.

Refer again to FIG. 2. Examples of possible architectural goals of the protocol include:
In the network-attached embodiments, compatibility with high-performance datacenter networks, particularly NIC features, on both the client 100 and the ISDM appliance 200 to minimize overhead. Note that no such network/NIC components may be needed in the local embodiment of the ISDM system, such that this goal would be moot.
As low latency as possible for the case of block requests from the client and communication prioritization to eliminate client waits for missing blocks. In the direct embodiment, prioritization may be implemented by adjusting the rate at which shared memory is polled for new messages.
Extensibility to support “anticipation” techniques that allow the ISDM appliance to better predict what page blocks will be requested, in order to reduce latency of future requests
Scalability, to be able to exploit even multi-core ISDM clients (in FIG. 3, six cores CPU Core 0, . . . , CPU Core 5, are illustrated by way of example only) and ISDM appliances, and multiple clients per server

Network configuration (for the network-attached embodiment)

The general network configuration may have the following features:
One or more NIC ports 416 and related driver(s) on each ISDM client are dedicated to communicating with the ISDM appliance(s) in the datacenter;
Each NIC port preferably supports multiple Tx and Rx queues. Network fabric end-to-end delay may then be kept much less than a desired page miss latency.
Packet size preferably larger than page size (for example, the system may use Jumbo frames in Ethernet).

### Transport Protocol

As for the transport protocol, it may have the following characteristics:
Layered on UDP-over-IP-over-Ethernet for switch and NIC compatibility. Each endpoint preferably has multiple UDP host+port addresses, to enable RSS+ feature in NICs to deliver frames and interrupts to specific logical processors on the client and appliance, over time
On the ISDM client, the Linux network stack may be bypassed (eventually), except for the DHCP functions that assign IP addresses to the NIC's used. Any physical networking fabric that can transfer messages from machine to machine may, however, replace UDP/IP/Ethernet (such as ROCE, CXL, . . . )
End-to-end acknowledgement, flow control, congestion control, etc., are part of the ISDM layer on top of the transport layer.

### Logical Flows in the ISDM Protocol

An ISDM service is started by creating a “session” connecting the ISDM client to the ISDM server, and is terminated by ending the session. The session provides the context for a number of related logical flows of messages back and forth. In the in the network-attached embodiment, these “logical flows” may be carried out using, for example, UDP datagrams, packing them into UDP datagrams to reduce packet overhead on the wire, and to take advantage of “fate-sharing” (the property of a datagram that the whole datagram either is delivered correctly or not at all.) Loss and duplication of UDP datagrams in the network may be managed by retransmission (if needed) of the logical flow data in each datagram, perhaps packed differently). In the direct embodiment, the logical flows in a session may be carried out using, for example, shared memory, in which case loss and duplication will not be concerns.

The primary function of the “data plane” of the ISDM protocol is copying page-sized blocks of memory between the ISDM client and server. Each standard page-block is typically 4096 bytes long and within the ISDM system may be identified by logical block number that is assigned by the client. In one prototype, a 52-bit (64-12) logical block number was used. This block number comprises the identifier used by the Linux client as a linear block address within the “swap device” provided by the ISDM attachment. Combined, then, the blocks in the example contain a page (commonly 4096 bytes) plus additional header information identifying the page within the Operating System of the main computer. This may be a few dozen bytes-whatever is needed to provide OS identification. In the current implementation in Linux it is the “swap entry” identifier.

The “paging flow” of page-blocks copied back and forth is the main logical flow. The mechanism of this flow is latency-critical, so its binding to UDP datagrams involves ensuring that these datagrams spend as little time in network queues as possible.

Other flows in the ISDM protocol may include message-exchanges, essentially remote procedure calls between the ISDM client and the ISDM appliance, or between the ISDM server and the client. These messages may be short, much smaller than one page, and implement control transactions between the two endpoints.

Message exchanges in a flow involve a request and implicit completion confirmation in each direction. Each flow is preferably assigned a distinct sequence number space for requests, which are to be executed in monotonic order of sequence number within the flow. The highest (or lowest, depending on the system designer's preference) completed request's sequence number may then be transmitted from the flow's target endpoint whenever requested.

### Page Block Copying

The ISDM protocol manages a page block table 250 (referred to here as the “Page Block Cache” or “PBC”). The Page Block Cache typically will correspond and be able to reference between 1% and 5% of the client's memory, though this is a tuning parameter. It may be indexed by Page Block Number and may be a sparse index (for example, using a small hash table).

The PBC's operation may be similar to the way a Write-Back Cache at level >1 in a standard multi-layer cached CPU architecture works. Linux, for example, transfers cold pages into the Page Block Cache via a swap-write API that specifies a block number and thus makes the content accessible to a ISDM client driver. After the swap-write returns, the ISDM client driver may (and usually will) execute a page-block copy to the ISDM appliance, though this may be delayed depending on other activities of the ISDM client driver, and metadata about the page blocks in the Page Block Cache's relative “temperature”, that is, frequency of use. The instance of the page in the Page Block Cache must be retained until it is either copied to the ISDM appliance, or the Linux kernel indicates that this page block number's content will not be needed again. It may be retained longer.

In the network-appliance embodiment, there are effectively two separate DRAM caches for pages-one (230) on the ISDM appliance that serves as a (big) cache of the ISDM appliance flash storage (235), and another on the client that serves as a (small) cache of the pages pushed from the ISDM.

In the MEXT-direct embodiment, there is no separate appliance, and thus no separate ISDM DRAM block pool 230—only the MEXT swap page pool (no numeric label) on the client. In other words, for MEXT-direct, it doesn't make sense to have two separate DRAM page caches, since all of that DRAM is local to the client.

The ISDM appliance may anticipate that a page will be needed in the near future. If so, it copies a Page Block from the ISDM appliance 200 to the client swap page pool 451. This copy may be kept in the Page Block Cache or may be deleted, since there is still a copy on the ISDM appliance. One way to implement the Page Block Cache physically is as a reserved block of physical memory as close to the physical CPUs running the client's OS as possible. It may either be embodied within an appliance or in a region of physical memory controlled by a dedicated device driver; in the MEXT system, this region may be on the hardware that runs the client.

When a CPU core in Linux discovers a page is missing, the page block is requested from the ISDM client driver, if it has been handed to the ISDM client driver. It is stored either in the Page Block Cache or on the ISDM or both. From looking at the Page Block Cache, it is known whether or not a copy has been sent to the ISDM appliance. To remove the page from the ISDM client driver, a request is sent to the ISDM appliance to remove it from its memory and the page is removed from the PBC. However, the unacknowledged request is preferably kept so it can be resent to ensure that eventually it will be removed.

On the other hand, if the PBC doesn't contain the page, a message may be sent to the ISDM appliance in a high-priority message flow to fetch the page block. The ISDM appliance then initiates a high-priority “copy” of the page to the PBC from the appliance, if the page hasn't recently been sent as part of anticipation of that page, and also sends a high priority message to the client ISDM driver to wake up the CPU core that is blocked waiting for the page miss. When the CPU core waiting for the page gets notified that the page block has arrived, it will find the page block in the PBC, so it then follows the logic above, both grabbing the page from the PBC, and issuing a message to the ISDM appliance to delete the page copy it has (which may be retransmitted until acknowledged).

### Messages and Page Blocks in Datagrams

As noted earlier, the ISDM protocol may comprise messages and page blocks sent between the ISDM client and the ISDM appliance. In the network-attached embodiment, these may be transported in UDP Datagrams in the initial implementation over an Ethernet fabric; in the direct embodiment, communication may be using shared memory instead. For example, the UDP datagrams may be transported in Ethernet Jumbo Frames, so that two or more full page blocks can fit in a UDP datagram, and several messages. UDP's checksum provides end-to-end error detection; if different protocols are used, then an appropriate error detection scheme may be used instead. The layout of the page blocks and messages in each UDP datagram is designed to allow NICs that support UDP header splitting on receive to avoid any copying of page blocks received. (Allowing zero-copy page block delivery into page block sized buffers is a performance improvement). Transmission of a UDP datagram may be done by a gather-style NIC command that uses a list of memory blocks containing page blocks and messages.

An embodiment may receive information from each client about ongoing memory management activity as the system runs, which may be specific to the management of each memory block in the operating system as the operating system manages its memory on behalf of the running workloads. This may include use of scanning blocks of virtual memory to sample accesses by the processor at any desired level of granularity. In one embodiment, this may be accomplished by scanning the per-PTE (page table entry) access bit (also known as the “A bit”), which is set by hardware when a page is first accessed. That scanning information, once captured, may then be sent to the ISDM for immediate analysis of patterns of usage that can be used to inform decisions about page reclaim strategies and also prefetching strategies used by the ISDM to move pages from the server to slower memory services, and back.

Such an embodiment may also capture the information from scanning into a real-time database to be stored for long-term, offline automatic analysis using AI learning routines that can predict likely access patterns. Routines such as Hidden Markov Models and General Purpose Transformer models using Deep Neural Networks are examples of known AI routines that may be used to generate forward-looking strategies to predict optimal choices, and may be used as the engine in the AI Learning and Prediction Processing module 220 shown in FIG. 2. In contemporary technology parlance, these technologies are called “Artificial Intelligence” (AI) techniques. This embodiment may use such methods offline as well, with the retained data being used for training a real-time model that can make context-specific choices about what blocks to move to optimize behavior.

Of course, both of these methods may be used in the same system. In other words, the AI module 220 may be initially trained using data captured for offline analysis of how a process in the client has accessed memory in the past, but then may refine and improve its predictive ability in real time by observing and using as additional training data the run-time memory access behavior of the client. As an alternative, or in addition to offline initial training, the AI module 220 may, for example, start with a freshly-initialized and possibly even random model and learn everything dynamically by observing and reacting to events as the workload runs. The ISDM could also be configured to wait until the model has trained sufficiently to make reasonable predictions before actually using those predictions to push pages.

The invention's use of “Artificial Intelligence” in memory management is novel, in particular, its ability to speculatively push memory to faster devices. In contrast, as noted earlier, traditional memory management approaches are usually based on static “heuristics”. The embodiment's design supports the requirements of using such “Artificial Intelligence” methods, which include both real-time, online training of the AI routine and “offline learning” that creates “online models” that can further learn.

The ISDM appliance 200 may be located in different entities, depending on the needs of a given implementation. In some implementations, such as the one illustrated in FIG. 1, the ISDM may be a component located in a computing system separate from the client and is thus network-attached. In other implementations, however, the ISDM may be installed within the client itself, as long as it is at a privilege level that allows it to access the needed memory components.

In FIG. 1, the client is depicted as communicating with the ISDM appliance over a network 110; in other words, FIG. 1 illustrates the “network-attached” embodiment. If the ISDM appliance is included within the client, then the communication need not be via any separate network, over a “wire”. One alternative, for example, would be communication via shared memory, that is, memory mapped into both the client and server portions of MEXT components. In the sense of the invention, “remote” therefore means “between separate processes”, even if they are within the same computing system, that is, a single client. As one example, the ISDM appliance could be embodied in one virtual machine (VM), whereas the client process could be in a different VM on the same platform.

It would even be possible to incorporate the ISDM into the operating system itself as part of its own memory management system. In such an implementation, the invention will still implement a notion of “pushing” memory pages in that a component in particular, the ISDM system, which is not found in existing clients, even in its operating system, would be applying learned, speculative, predictive management of memory access based on analysis of actual client behavior rather than applying static assumptions. Again, this would be in contrast to conventional pre-fetching, that is, pulling of memory pages based on static assumptions.

In general, the MEXT system may be viewed as a virtual device, that is, a software-defined system component that can be realized in a number of physical forms. These forms include using part of the hardware in the same machine as the running system, where that part of the hardware is isolated by a protection boundary that allows the MEXT system to operate independently, or in a remote physical system. The only requirement is that the MEXT system requires access to memory, to CPUs that can access that memory, and a communications (I/O) path between the main system and MEXT system.

Two main embodiments of the MEXT device are: 1) a remote server computer (Appliance) connected by a high-speed, low-latency network path as the communications link, and 2) portions of the computer running the main operating system with one or more independent CPU cores communicating using shared memory, one or more of which may optionally be dedicated to running the MEXT appliance. This latter embodiment 2) may therefore be considered to be a “direct” configuration, which may be implemented using dedicated, isolated processes being run by the main system's OS, configured so they are isolated from all other activity in the main system, similar to the technique known as “user-mode polled I/O” in Linux systems.

At this point, several of the advantages of embodiments of the invention should be apparent. Some of these stem from the ability of the invention to operate in multiple contexts. Prior art cache-line prefetching schemes, including the known Voyager and TransFetch systems, assume that there is only one application, that is, a single context for the entire run. The present inventors realized, and thus the invention takes into account, the need to distinguish between multiple contexts, such as the numerous different running processes. Specifically, most prior work has been focused on predicted cache lines in a single sequential physical processor (core).

This invention, in contrast, is able to predict misses by a single process or thread-abstract OS structures that are not known by the processor itself. Note that a process or thread may execute on different processors during its execution. Analyzing only a single processor's cache line will therefore often fail to provide enough information to lead to optimal or even significantly improved pre-fetching performance even if AI/ML techniques are used. This invention is therefore able to follow the actual relationships among accesses, as well as paying attention to distinctions among accesses. In addition, structures such as the instruction pointer may be qualified by the process or thread context it is used in, enabling the AI module 220 to further make distinctions. By making such information available in real time to the AI component, the present invention enables more powerful AI prediction systems to be trained and used.

The idea of a “context” can be generalized to include other application-level or system-level information. For example, the AI module 220 could receive as inputs information relating to hardware performance counters, software counters, or system utilization statistics to monitor events (e.g., those listed in Table 1, and, among additional examples, cache misses, TLB misses, CPU load, I/O activity, etc.) to help detect phase changes representing different behaviors over time within a single application, process, or thread.

The failure of prior art systems to take contextual information into account extends even to known systems such as Pythia (see Beral, et al., “Pythia: A Customizable Hardware Prefetching Framework Using Online Reinforcement Learning”, in MICRO 2021) that attempt to provide limited feedback: even such systems fail to take into account or even realize the usefulness of information relating to process/thread interactions.

As mentioned above, this MEXT invention does not require specific hardware support; rather, the components shown in FIGS. 2 and 3 are either already present in a typical computing system or, with respect to those that carry out the unique operations used by the invention, may be chosen to be implemented purely as software. In particular, the software modules 220, 400, 412 are embodied as processor-executable code that is stored in the usual volatile and/or non-volatile storage components of the client 100 and ISDM appliance 200 (unless the appliance is included within the client system itself) and cause the respective system's processor(s) to perform the corresponding respective functions described above. One advantage of this is that the modules can be updated in the field with better AI methods that process the same embeddings of input and output. The modular placement of the AI component and ease of replacement without changing the mechanics of page movement and collecting the embedding data is an advantage that a hardware solution cannot have.

In the embodiments described above, the MEXT system observes streams of events that occur while the workload is executing on a client processor. Events are ordered in time or may be other causality-induced sequences. The MEXT system uses events that occur during the OS's memory management algorithms, and contain descriptive information, such as the virtual memory address of a page miss, the creation and destruction of a virtual address space, etc. It would be possible, however, to include an additional software module—and event generation module—that also examines client data, including executable code stored in memory, and defines the presence of certain data and/or code as a trigger event that triggers the MEXT system to push pages that it predicts an imminent need for.

1. A memory management method for a computing system, in which the computing system includes an operating system (OS) that supports virtual memory and that accesses a relatively faster memory and at least one relatively slower memory, the memory management method comprising:
inputting from the OS to a machine learning component information corresponding to events associated with a process running on the OS, in which the machine learning component is configured within a software appliance that is logically separate from the OS;
in the machine learning component,
synthesizing a page access model from at least one sequence of the events inputted from the OS;
identifying patterns in the at least one sequence of the events;
in real time, predicting page misses by the process in the relatively faster memory that are likely to happen by the process and identifying most-likely-to-be-missed pages that the process may attempt to access in the relatively faster memory; and
moving at least some of the most-likely-to-be accessed pages from the relatively slower memory to the relatively faster memory,
whereby the pages the process will attempt to access in at least one relatively faster memory are predictively moved to and made available to the process in at least one relatively faster memory before the process attempts access.

2. The method of claim 1, in which:
the software appliance accesses a local relatively fast memory;
the software appliance and the computing system communicate over a network; and
the most-likely-to-be accessed pages are moved over the network.

3. The method of claim 1, in which:
the software appliance and the OS run on a common hardware platform; and
the most-likely-to-be accessed pages are moved into a memory space shared by the software appliance and the OS.

4. The method of claim 1, in which the pages to be moved are moved independently of any transfer request by the process and independently of any page miss handler controlled by the OS.

5. The method of claim 1, in comprising predicting the page misses according to an access prediction criterion.

6. The method of claim 5, in which the access prediction criterion is a function of an output of the page access model.

7. The method of claim 6, comprising generating the output as a list of pages currently residing in the software appliance estimated to be needed by the process within a near future.

8. The method of claim 7, further comprising:
generating the list of pages as a ranked list; and
choosing a cutoff of the ranked list that is adjustable in real time in order to adjust a whereby a dimensionality of the page access model.

9. The method of claim 5, in which the access prediction criterion is that a score that the process will refer to other pages within a number of subsequent memory access operations exceeds a threshold score.

10. The method of claim 9, in which the score is a probability.

11. The method of claim 5, in which the access prediction criterion is that a score that predicted pages are likely to be needed by the process before other, colder pages resident in the relatively faster memory exceeds a threshold score.

12. The method of claim 11, in which the score is a probability.

13. The method of claim 5, further comprising:
including in the access prediction criterion a threshold score that predicted pages are likely to be needed; and
dynamically adjusting the threshold score to change how many pages are designated as the most-likely-to-be accessed pages.

14. The method of claim 13, in which the score is a probability.

15. The method of claim 1, in which the software appliance directs the machine learning component to predict the page misses upon detection of at least one trigger event.

16. The method of claim 15, further comprising:
designating at least one page in the relatively faster memory as a trigger page;
designating in the page access model pages associated with the trigger page as the most-likely-to-be accessed pages when the process attempts to access the trigger page, whereby the attempted access is the trigger event.

17. The method of claim 15, in which the at least one trigger event includes process behavior information in addition to page misses.

18. The method of claim 1, in which
the process is one of a plurality of processes running concurrently on the OS; and
the page access model is synthesized specific to the process, independent of behavior of any other of the plurality of processes.

19. The method of claim 1, further comprising:
including page addresses in the information input from the OS to the machine learning component; and
reducing the number of page addresses used as inputs to the machine learning component by sampling.

20. The method of claim 19, in which the sampling is a function of an accuracy rate of the machine learning component.

21. The method of claim 19, in which the sampling is sampling of page addresses.

22. The method of claim 21, in which the sampling also includes sampling of the input information in addition to page addresses.

23. The method of claim 1, further comprising
scanning blocks of the virtual memory to sample accesses by the process; and
inputting resulting scanning information to the machine learning component.

24. The method of claim 1, in which the sequence of events includes at least one event chosen from the group of events comprising a page miss, detection of contextual embedding actions including process/thread scheduling, the creation and destruction of a virtual address space, page hits, and page swapping.

25. The method of claim 1, comprising carrying out the steps of claim 1 independent of specific hardware support in the computing system.

26. The method of claim 1, in which the information input to the machine learning component includes at least one of the information items including hardware performance counters, software counters, system utilization statistics cache misses, translation lookaside-buffer (TLB) misses, CPU load, I/O activity, a thread identifier, the process' name, offset of a page in a process virtual address space section, pressure stall information metrics, a page swap-out time, a time of most recent use of a respective page, process address space size upon swap-out, process cumulative page fault data when upon swap-out, process cumulative runtime upon swap-out of a memory block, I/O waiting time upon memory block swap-out, process working set size at swap-out, page sharing by more than one process/thread at swap-out, page unaccessed time exceeding an access time threshold, page accessed before becoming unaccessed, page accessed shortly after swap-out, identification of a number of pages accessed by context before a most recent page miss on a respective page, and a time at which a page block was first accessed in a virtual memory of a context.

27. A memory management system for a computing system, in which the computing system includes an operating system (OS) that supports virtual memory and that accesses a relatively faster memory and at least one relatively slower memory, the system comprising:
a machine learning component inputting from the OS information corresponding to events associated with a process running on the OS, in which the machine learning component is configured within a software appliance that is logically separate from the OS;
in which the machine learning component is provided
to synthesize a page access model from at least one sequence of the events inputted from the OS;
to identify patterns in the at least one sequence of the events;
to predict, in real time, page misses by the process in the relatively faster memory that are likely to happen by the process and identifying most-likely-to-be-missed pages that the process may attempt to access in the relatively faster memory; and
said system further being provided to move at least some of the most-likely-to-be accessed pages from the relatively slower memory to the relatively faster memory,
whereby the pages the process will attempt to access in at least one relatively faster memory are predictively moved to and made available to the process in at least one relatively faster memory before the process attempts access.

28. The system of claim 27, in which:
a local relatively fast memory accessed by the software appliance;
a network over which the software appliance and the computing system communicate;
in which the memory management system is provided to move the most-likely-to-be accessed pages over the network.

29. The system of claim 27, further comprising:
a common hardware platform on which both the software appliance and the OS are run; and
a shared memory that is shared by both the memory management system and the OS and into which said most-likely-to-be accessed pages are moved.

30. The system of claim 27, in which the memory management system is provided to move pages independently of any transfer request by the process and independently of any page miss handler controlled by the OS.

31. The system of claim 27, in which the machine learning component is configured to predict the page misses according to an access prediction criterion.

32. The system of claim 27, in which the software appliance is configured to detect at least one trigger event direct the machine learning component to predict the page misses upon detection of at least one trigger event.

33. The system of claim 32, in which:
at least one page in the relatively faster memory is designated as a trigger page;
pages associated with the trigger page are designated in the page access model as the most-likely-to-be accessed pages when the process attempts to access the trigger page, whereby the attempted access is the trigger event.

34. The system of claim 32, in which the at least one trigger event includes process behavior information in addition to page misses.

35. The system of claim 27, in which
the process is one of a plurality of processes running concurrently on the OS; and
the page access model is synthesized specific to the process, independent of behavior of any other of the plurality of processes.

36. The system of claim 27, in which
page addresses are included in the information input from the OS to the machine learning component; and
the memory management system is configured to reduce the number of page addresses used as inputs to the machine learning component by sampling.

37. The system of claim 1, in which the memory management system is configured
to scan blocks of the virtual memory to sample accesses by the process; and
to input resulting scanning information to the machine learning component.

38. The system of claim 1, in which the sequence of events includes at least one event chosen from the group of events comprising a page miss, detection of contextual embedding actions including process/thread scheduling, the creation and destruction of a virtual address space, page hits, and page swapping.
